(19) United States
(12) Patent Application Publication
(10) Pub. No.: US 2018/0038719 A1
(43) Pub. Date: Feb. 8, 2018

(54) FLUID METER, IN PARTICULAR FOR LIQUIDS, HAVING AN INTEGRATED ADJUSTMENT DEVICE

(71) Applicant: DIEHL METERING S.A.S., Saint Louis (FR)

(72) Inventors: ALEXANDRE DEVILLERS, ENSISHEIM (FR); CHRISTOPHE MUNCK, HAUSGAUEN (FR)

(21) Appl. No.: 15/667,088

(22) Filed: Aug. 2, 2017

(30) Foreign Application Priority Data
Aug. 2, 2016 (FR) 1657484

(51) Int. Cl. G01F 1/08; F01D 25/24; G01F 25/00; F01D 5/04

(52) U.S. Cl. CPC G01F 1/08; F01D 5/04; F01D 25/24; G01F 25/0007; F05D 2230/20

(57) ABSTRACT

A meter, in particular a meter for fluids, especially liquids and preferably water, includes a housing having a fluid inlet opening and a fluid outlet opening. A turbine having radial blades is actuated by a movement of the fluid between the inlet and outlet openings. A device for measuring the movement of the turbine is mounted on the housing. A device for deviating a flow of the fluid is provided between the inlet opening and those radial blades of the turbine which are closest to the inlet opening. The flow deviating device is actuable from outside the housing, preferably manually and directly, in particular permitting easier manual adjustment of the meter.

### CROSS-REFERENCE TO RELATED APPLICATION

This application claims the priority, under 35 U.S.C. § 119, of French Patent Application FR 1657484, filed Aug. 2, 2016; the prior application is herewith incorporated by reference in its entirety.

### BACKGROUND OF THE INVENTION

### Field of the Invention

The present invention relates to the field of devices or apparatuses for measuring fluids, such as meters for water, gas and the like, in particular those installed in individual residences.

In order to guarantee a high level of reliability, meters have to be calibrated in order to ensure, within an acceptable margin of error, that the quantity or flow rate of fluid which has been measured does indeed correspond to that which has passed through the measuring instrument.

That involves measuring, for example, the measurement error actually observed (in %) as a function of the flow rate (in liters/hour) and thus establishing a curve, at least a significant portion of which has to fall within a predefined frame of tolerances which is judged to be acceptable. To that end, currently known meters are provided with an attached adjustment part formed of a small deflector that is mounted eccentrically (with respect to the axis of rotation of the turbine of the meter) and is able to pivot on itself. That device is mounted at the inlet into the circular main chamber of the meter, into which the fluid arrives before being conveyed through the turbine and evacuated from the chamber through an outlet which is generally located diametrically opposite. Verification and calibration are generally carried out empirically by turning the flow deflector until the resulting change causes the curve of the measure of the error observed to “fall” within the predefined frame of tolerances, at least over the relevant flow rate ranges, that is to say those for which it is necessary that the measurement error is well below the established tolerance.

However, that type of device and mode of operation have a certain number of drawbacks.

Indeed, the fact of adding an additional adjustment part complicates the manufacture of the meter, thus giving rise to increased costs. Moreover, that part is not easily accessible from the outside and is difficult to handle, making the above adjustment delicate in practice. Finally, for structural reasons, the part which can pivot through 360° can have only relatively small dimensions, and therefore a relatively small surface area of the deflector proper which, in addition to its eccentric location, provides only a slight or moderate effect on the fluid flow, and therefore reduced room for maneuvering for the operator when the operator has to adjust the meter for different flow rates or volumes.

### SUMMARY OF THE INVENTION

It is accordingly an object of the invention to provide a fluid meter, in particular for liquids, having an integrated adjustment device, which overcomes or counters at least some of the hereinafore-mentioned disadvantages or drawbacks of the heretofore-known devices of this general type.

With the foregoing and other objects in view there is provided, in accordance with the invention, a meter, in particular a meter for fluids, especially for liquids and preferably for water, which comprises a housing provided with a fluid inlet opening and a fluid outlet opening, a turbine having radial blades and being actuated by a movement of the fluid between the inlet and outlet openings, the housing having a device mounted thereon for measuring the movement of the turbine, and a device for deviating the flow of fluid being provided between the inlet opening and those radial blades of the turbine which are closest to the inlet opening, the flow deviating device being actuable from outside the housing, preferably manually and directly.

By virtue of this construction, the meter is simplified and the adjustment operation is made much easier by the fact that the operator can more easily actuate the adjusting device, and that the actuation has a greater effect on the fluid flow, which increases the accuracy of the adjustment and thus the margin for maneuvering for the operator in terms of calibration.

Other features which are considered as characteristic for the invention are set forth in the appended claims.

Although the invention is illustrated and described herein as embodied in a fluid meter, in particular for liquids, having an integrated adjustment device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, vertical-sectional view through the middle of a water meter according to the invention;

FIG. 2 is an enlarged, partly sectional and partly perspective view of the interior of the meter of FIG. 1;

FIGS. 3A, 3B and 3C are perspective views of a support element for a meter according to the invention; and

FIG. 4 is a perspective view of the meter according to the invention during an adjustment operation, along with a graph showing various associated measurement curves.

### DETAILED DESCRIPTION OF THE INVENTION

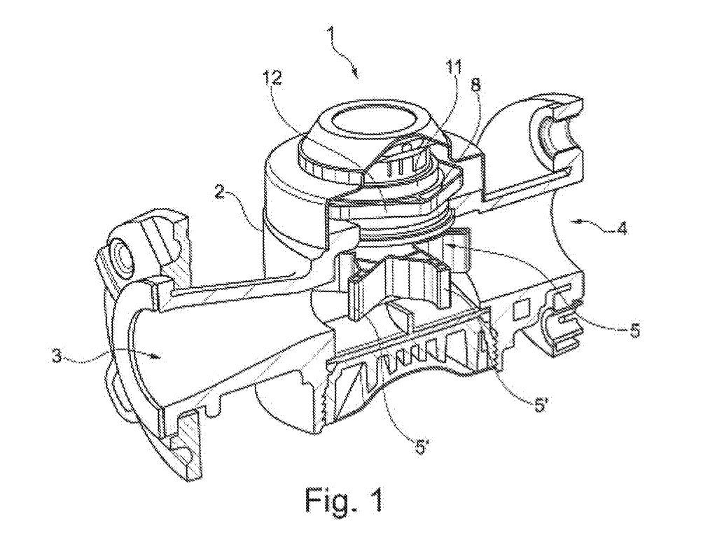

Referring now to the figures of the drawings in detail and first, particularly, to FIG. 1 thereof, there is seen a diagrammatic illustration of a conventional meter 1, in this case, for example, a water meter. The meter takes the form of a main housing 2 (generally of cast iron) which contains a measurement device that is known per se and is provided with a lid and a removable cover as well as fluid inlet and outlet ducts, which are also made of cast iron, preferably in one piece with the housing 2. In accordance with the present invention, the meter 1, in particular a meter for fluids, especially for liquids and preferably water, is therefore distinguished in that it includes substantially a housing 2 provided with a fluid inlet opening 3, a fluid outlet opening 4 and a turbine 5 having radial blades 5′ and being actuated by a movement of the fluid between the inlet opening 3 and outlet opening 4. A device for measuring the movement of the turbine 5 is mounted on the housing 2. A device 6 for deviating the flow of fluid is provided between the inlet opening 3 and those radial blades 5′ of the turbine 5 which are closest to the inlet opening 3. The device 6 is actuable from outside the housing 2, preferably manually and directly. The device 6, which is not shown in FIG. 1, will be described in greater detail below.

For the sake of clarity, FIG. 1 shows certain internal parts of the meter 1, such as the measuring device or the radial blades 5′, as whole, three-dimensional parts. The geometry of the radial blades 5′ is also given as an illustrative and non-limiting example. The flow rate or quantity of the fluid being used is to be measured. It is therefore clear that the fluid to be measured enters on the left, encounters the radial blades 5′ closest to the inlet opening 3, and is then transported through the turbine 5 to re-emerge on the right at the outlet opening 4. A support element 8 topping, capping and receiving a vertical axle of the turbine 5 is provided with the non-illustrated device 6. The support element 8 is secured to and held on the housing 2, at a bearing face, by a holding nut 12. Two faces of a polygonal peripheral contour of the holding nut 12 are shown in the figure. The support element 8 also serves as a housing for the device for measuring the movement of the turbine. The make-up and operation of the measuring device are also known per se and require no further explanation in the context of the present invention. It is sufficient that this measuring device allows the user access to those parameters, of the meter 1 in question, that are to be measured and adjusted, for example by way of a conventional optical sensor and/or a conventional counter.

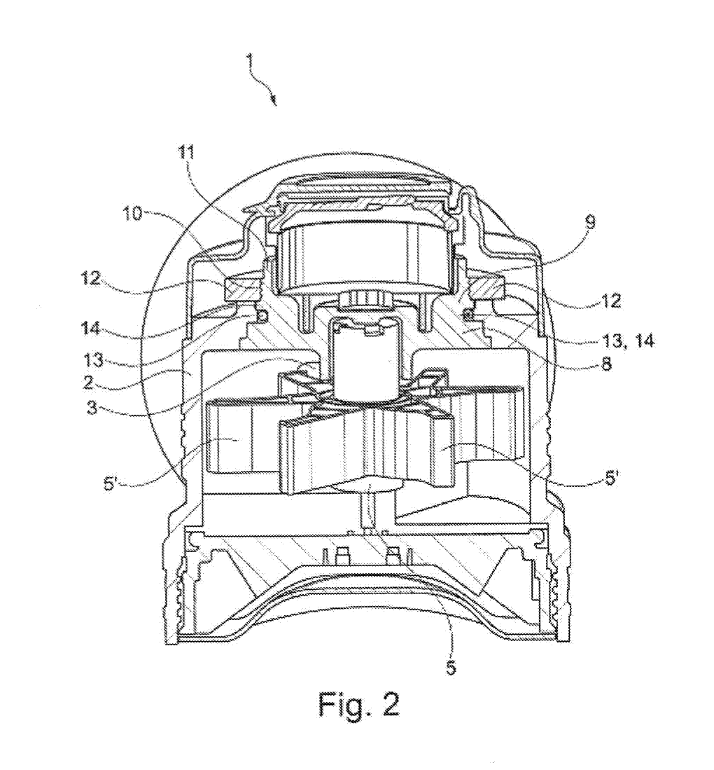

FIG. 2 is an enlarged view of the central region of the meter 1 of FIG. 1, and better shows various constituent parts which will be described in greater detail later on, in particular the support element 8.

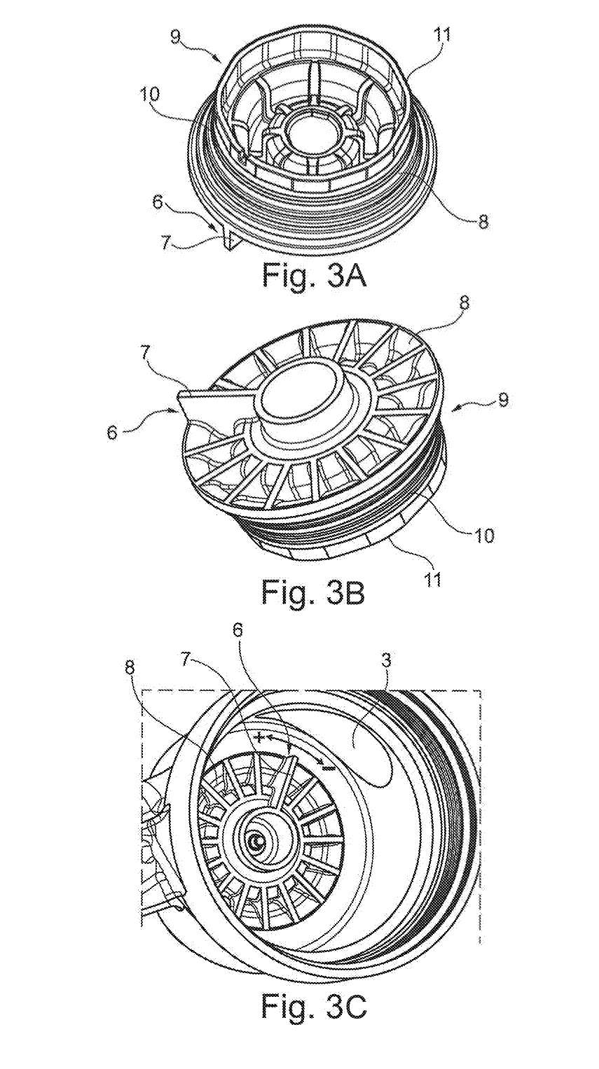

As is shown clearly in FIGS. 3A, 3B and 3C in relation to FIGS. 1 and 2, the meter 1 according to the invention is distinguished in that the device 6 for deviating the flow is in the form of an orientable wall portion or chicane 7, which is preferably planar and is disposed between the inlet opening 3 and the radial turbine blades 5′ closest to the inlet opening 3. The orientable chicane 7 extends radially and in a substantially vertical plane. Depending on the chosen geometry, this plane is more or less parallel to that formed by one of the radial blades 5′ of the turbine 5.

Advantageously, the orientable chicane 7 and the turbine 5 are coaxial, and the orientable chicane 7 is secured to a support element 8 which is also mounted so as to be free to rotate coaxially about the axis of rotation of the turbine 5, and the movement in rotation of which can be controlled from outside the housing 2, preferably manually and directly.

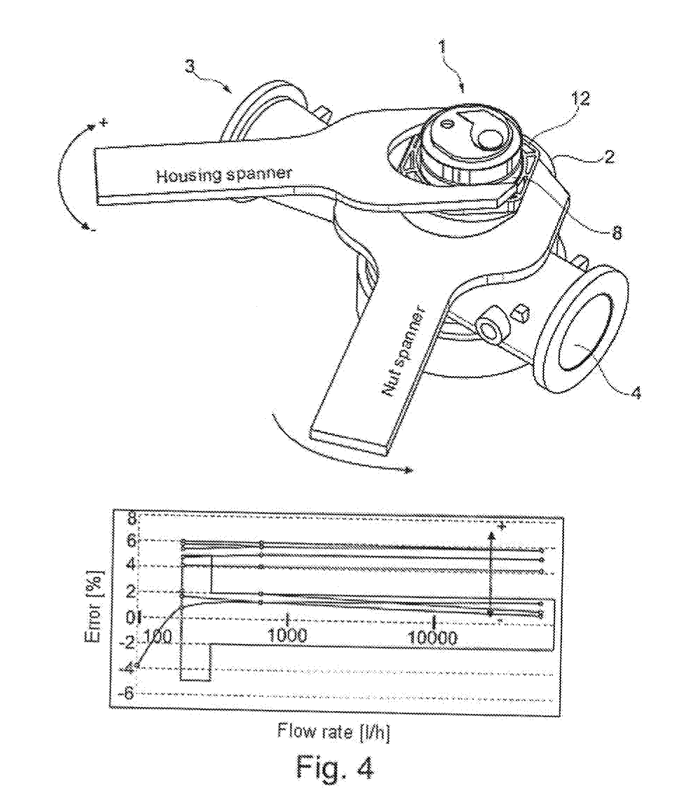

This mode of operation will be described later on, in particular in relation to FIG. 4.

According to the invention, the meter is further distinguished in that the support element 8 includes a base part in the form of a horizontal circular disc that extends perpendicular to the vertical axis of rotation of the turbine 5 and is provided with a wall portion which extends radially and vertically from the lower face of the disc so as to form an orientable chicane 7 for the fluid flow. The upper face of the disc is provided with a circular collar or skirt 9 that extends as far as an external portion of the housing 2 in which the fluid that is to be measured flows. It is possible, by rotating the collar 9, to control the orientation of the wall portion forming the orientable chicane 7 for deviating the fluid.

As is shown in particular in FIGS. 3A and 3B, the collar 9 has, in its outer portion facing the user, an annular thread 10. This annular thread 10 of the collar 9 is advantageously extended, in the vertical direction away from the housing 2, by a free wall portion 11 of the collar 9, the external shape of which is polygonal. Thus, this polygonal contour has, on its outer surface, a succession of rectangular faces which permit good engagement with a spanner as shown in FIG. 4.

According to another feature, a holding nut 12 engages with the annular thread 10 of the collar 9 of the support element 8 in order to hold it on an external wall of the housing 2 of the meter 1 (see in particular FIG. 2).

Preferably, the external shape of the holding nut 12 is polygonal. Such a geometry, in the manner of the free wall 11, will make it easier to use the invention, as will also be shown in relation to FIG. 4, by providing good engagement with the nut spanner as shown.

In order to ensure optimal sealing of the meter 1, it is possible to also advantageously provide that the collar 9 of the support element 8 has at least one annular groove 13 provided with an O-ring 14 in order to seal the support element 8 with respect to the housing 2 of the meter 1.

As already mentioned, the meter 1 according to the invention is further distinguished in that the collar 9 of the support element 8 is constructed to receive at least part of the device for measuring the movement of the turbine, which is used to make it possible to measure the flow rate and/or the volume of fluid passing through the meter 1. This can be made possible by the walls of the collar 9, and by a conventional mechanical device for receiving, holding and/or securing the device, such as bearings, etc.

According to the invention, the device 6 (that is to say the chicane 7) and the support element 8 are made in one piece of a synthetic material, preferably an injection-molded plastic material. This makes it possible to reduce the production costs for a meter, saving one part, one assembly operation and substituting the brass which is normally used for a less costly material. Radial reinforcing ribs, recesses, grooves such as the annular groove 13, etc. can also be readily created in this manner in the body of the support element 8.

As is shown in FIG. 4 in relation to FIG. 3C, it is sufficient, in order to calibrate the meter 1, to simply turn the housing spanner sufficiently in the +/− direction indicated, loosening then re-tightening the holding nut 12 with a second spanner in order to pivot the device 6 until the curve measuring the measurement error (%) is close enough to the established tolerances, that is to say until the effective measurement curve is completely or at least partially contained within the tolerance frame, which is shown in this case in the form of a reclining “T” in the graph associated with FIG. 4. This adjustment operation can be carried out directly on a bench without it being necessary to remove the counter and the optical sensor that are present in the measuring device of the meter 1. This makes it possible to save time and to increase reliability and/or flexibility, since the margin for maneuvering (see the range between the + and the − in the graph associated with FIG. 4) is greater than in the conventional devices known from the prior art.

Of course, the invention is not limited to the embodiments described and represented in the appended drawings. Modifications remain possible, in particular with respect to the make-up of the various elements, or by substitution of equivalent techniques, without in so doing departing from the protective scope of the invention.

1. A meter for fluids, liquids or water, the meter comprising:
a housing having a fluid inlet opening and a fluid outlet opening;
a turbine having radial blades, said turbine being actuated by a movement of the fluid between said inlet opening and said outlet opening causing a movement of said turbine to be measured by a device mounted on said housing, said radial blades including radial blades closest to said inlet opening; and
a device disposed between said inlet opening and said radial blades closest to said inlet opening for deviating a flow of the fluid, said flow deviating device being actuable from outside said housing.

2. The meter according to claim 1, wherein said flow deviating device is actuable manually and directly from outside said housing.

3. The meter according to claim 1, wherein said flow deviating device is an orientable wall portion or chicane disposed between said inlet opening and said radial turbine blades closest to said inlet opening, said orientable wall portion or chicane extending radially and in a substantially vertical plane.

4. The meter according to claim 3, wherein said orientable wall portion or chicane is planar.

5. The meter according to claim 3, which further comprises:
a support element;
said orientable wall portion or chicane and said turbine being coaxial about an axis of rotation of said turbine;
said orientable wall portion or chicane being secured to said support element;
said support element being mounted for freely rotatable movement coaxially about said axis of rotation of said turbine; and
said rotatable movement of said support element being controlled from outside said housing.

6. The meter according to claim 5, wherein said rotatable movement of said support element is controlled manually and directly from outside said housing.

7. The meter according to claim 5, wherein:
said axis of rotation of said turbine is vertical;
said support element includes a base part formed as a horizontal circular disc extending perpendicular to said vertical axis of rotation of said turbine;
said disc having a lower face, an upper face and a wall portion extending radially and vertically from said lower face to form said orientable wall portion or chicane for the fluid flow;
said upper face having a circular collar or skirt extending as far as an external portion of said housing in which the fluid to be measured flows; and
said circular collar or skirt being rotatable to control an orientation of said wall portion forming said orientable wall portion or chicane for deviating the fluid.

8. The meter according to claim 7, wherein said circular collar or skirt has an outer portion facing a user and an annular thread at said outer portion.

9. The meter according to claim 8, wherein said annular thread of said circular collar or skirt is extended by a free wall portion of said circular collar or skirt having an external polygonal shape.

10. The meter according to claim 8, which further comprises a holding nut engaging said annular thread of said circular collar or skirt of said support element to hold said support element on an external wall of said housing.

11. The meter according to claim 10, wherein said holding nut has a polygonal external shape.

12. The meter according to claim 7, wherein said circular collar or skirt of said support element has at least one annular groove provided with an O-ring for sealing said support element relative to said housing.

13. The meter according to claim 5, wherein said flow deviating device and said support element are made in one piece of a synthetic material.

14. The meter according to claim 13, wherein said synthetic material is an injection-molded plastic material.
